(19) United States
(12) Patent Application Publication
(10) Pub. No.: US 2025/0003611 A1
(43) Pub. Date: Jan. 2, 2025

(54) BATHROOM EXHAUST FAN SWITCHING DEVICE

(71) Applicant: Richard Fustos, Bordentown, NJ (US)

(72) Inventor: Richard Fustos, Bordentown, NJ (US)

(21) Appl. No.: 18/751,952

(22) Filed: Jun. 24, 2024

Related U.S. Application Data
(60) Provisional application No. 63/524,215, filed on Jun. 29, 2023.

(51) Int. Cl. F24F 7/007; F04D 27/00; F24F 11/00

(52) U.S. Cl. CPC F24F 7/007; F04D 27/00; F24F 11/0001; F05D 2270/333

(57) ABSTRACT

A bathroom exhaust fan switching device for turning on a bathroom exhaust fan automatically upon start of a shower includes a switching module, which can be installed in a bathroom in-line with the bathroom exhaust fan, which is operationally engaged to an electrical circuit. The switching module comprises a transducer, a relay, and a microprocessor. The transducer converts sound into an electrical signal. The relay is operationally engaged to the electrical circuit. The microprocessor, which is operationally engaged to the transducer and the relay, is programmed to recognize a sound signature of a shower in the bathroom to the exclusion of sound signatures of other water fixtures in the bathroom. The microprocessor actuates the relay upon receipt of an electrical signal from the transducer bearing the sound signature of the shower so that the bathroom exhaust fan is powered on to remove moist air from the bathroom.

### (b) CROSS-REFERENCE TO RELATED APPLICATIONS

I hereby claim the benefit under 35 U.S.C. Section 119 (e) of U.S. Provisional application 63/524,215 filed Jun. 29, 2023.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to automatic switches and more particularly pertains to a new automatic switch for turning on a bathroom exhaust fan automatically upon start of a shower. Forgetting to turn on the bathroom exhaust fan during a shower occurs often and can result in damage, such as peeling paint, mold, slipping upon bathroom floors, or the like.

### (2) Description of Related Art Including Information Disclosed Under 37 CFR 1.97 and 1.98

The prior art relates to automatic switches. Existing options for turning on a bathroom exhaust fan automatically upon start of a shower are not reliable and/or costly. For example, humidity sensors can be used to actuate bathroom exhaust fans but do so approximately 10 minutes after start of a shower.

### (h) BRIEF SUMMARY OF THE INVENTION

An embodiment of the disclosure meets the needs presented above by generally comprising a switching module, which is configured to be installed in a bathroom so that the switching module is in-line with a bathroom exhaust fan, which is positioned in the bathroom and which is operationally engaged to an electrical circuit. The switching module comprises a transducer, a relay, and a microprocessor. The transducer is configured to convert sound into an electrical signal. The relay is operationally engaged to the electrical circuit. The microprocessor, which is operationally engaged to the transducer and the relay, is programmed to recognize a sound signature of a shower in the bathroom to the exclusion of sound signatures of other water fixtures in the bathroom. The microprocessor actuates the relay upon receipt of an electrical signal from the transducer bearing the sound signature of the shower so that the bathroom exhaust fan is powered on to remove moist air from the bathroom.

Another embodiment of the disclosure includes a bathroom exhaust fan switching system, which comprises a bathroom exhaust fan, which is positioned in a bathroom having a shower. The bathroom exhaust fan is in operational engagement with an electrical circuit. A switching module, according to the disclosure above, is installed in-line with the bathroom exhaust fan. The microprocessor actuates the relay upon receipt of an electrical signal from the transducer that corresponds to the sound signature of the shower. Thus, the bathroom exhaust fan is powered on to remove moist air from the bathroom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a bathroom exhaust fan switching device according to an embodiment of the disclosure.

FIG. 2 is a front view of an embodiment of the disclosure.

FIG. 3 is a cross-sectional view of an embodiment of the disclosure.

FIG. 4 is a block diagram of an embodiment of the disclosure.

FIG. 5 is an in-use view of an embodiment of the disclosure.

### (j) DETAILED DESCRIPTION OF THE INVENTION

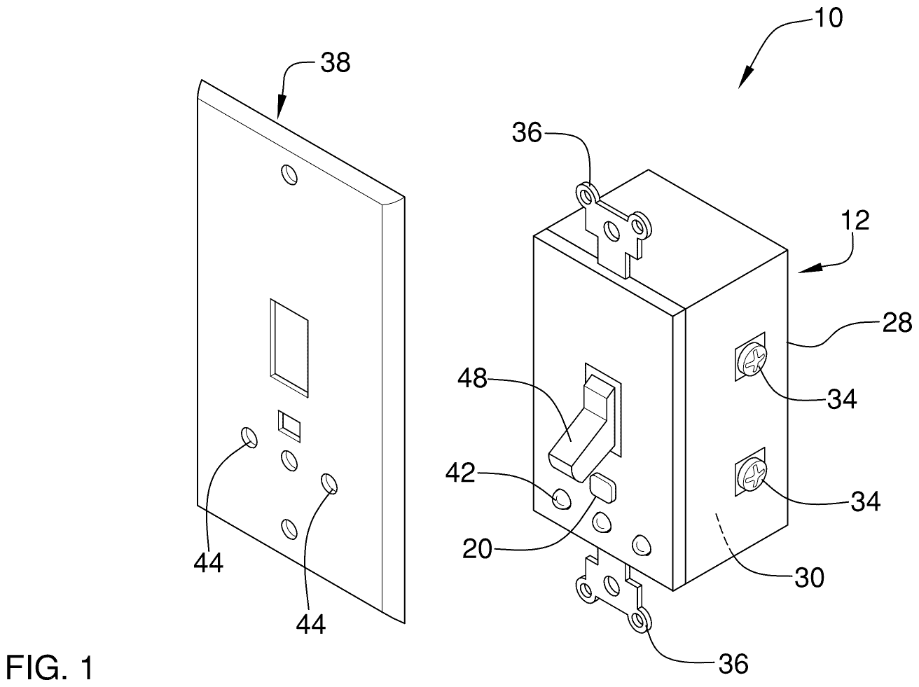

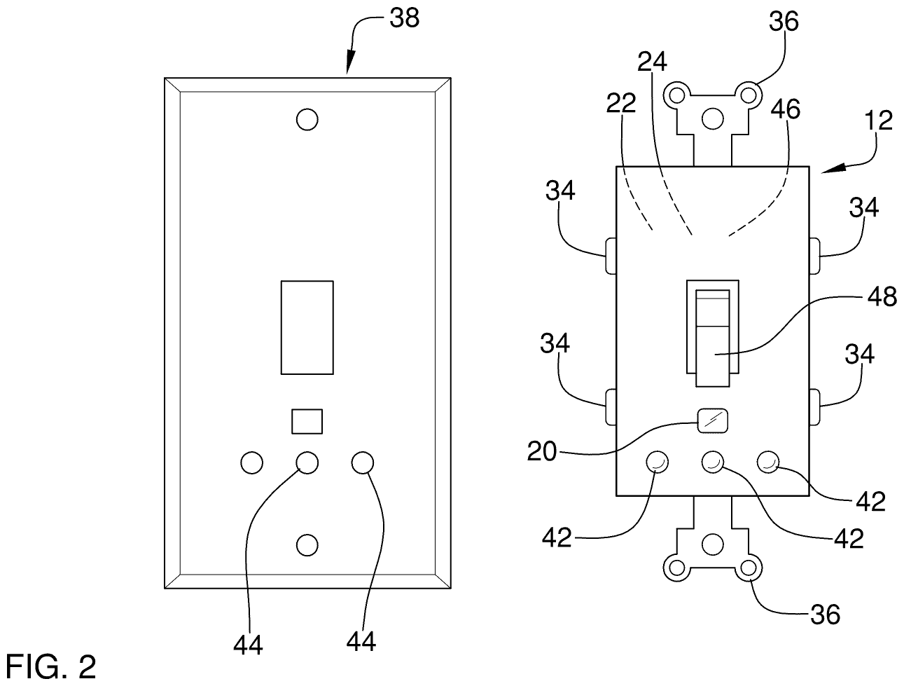

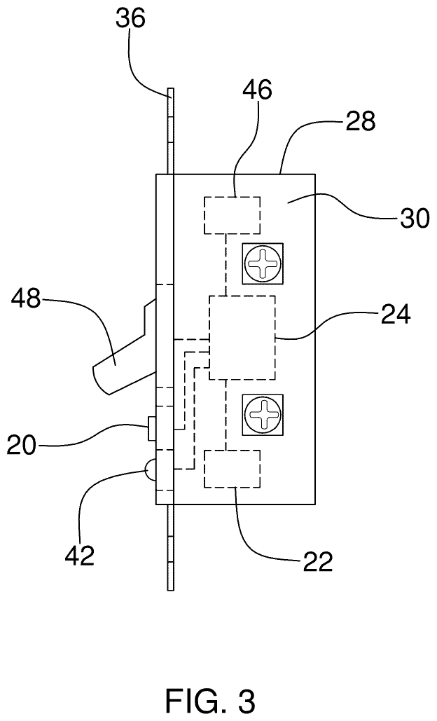

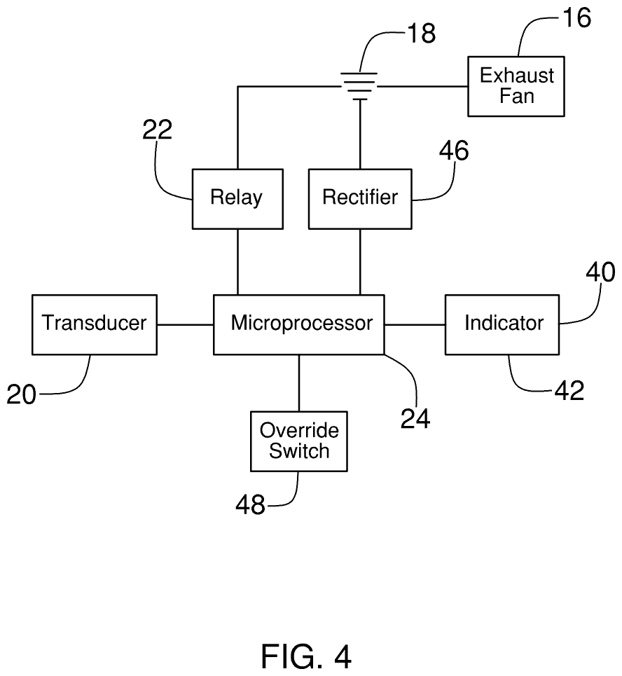

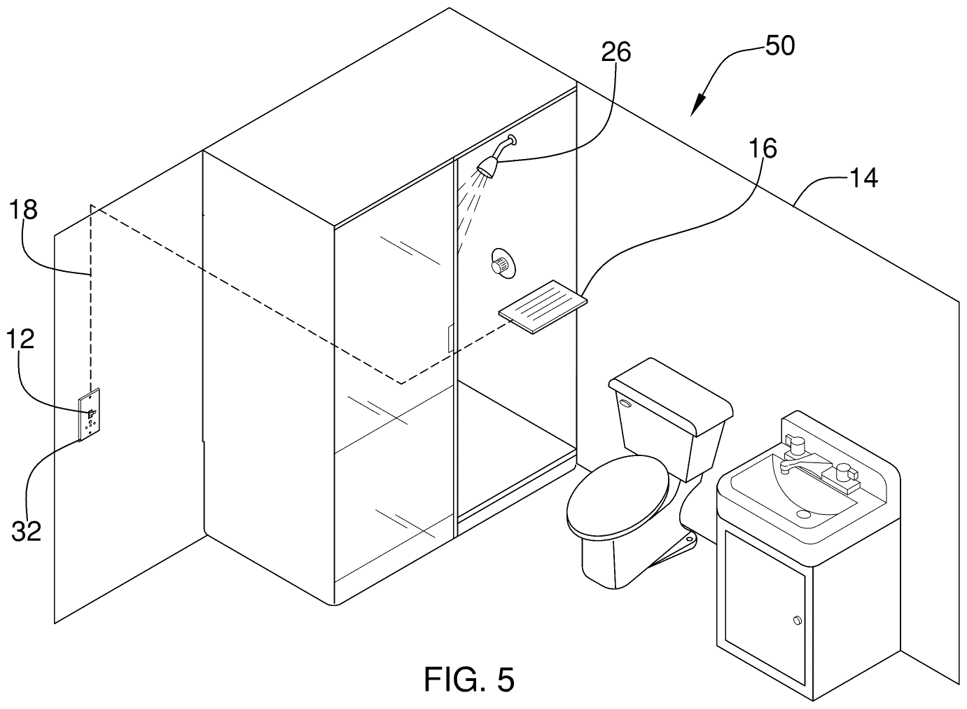

With reference now to the drawings, and in particular to FIGS. 1 through 5 thereof, a new automatic switch embodying the principles and concepts of an embodiment of the disclosure and generally designated by the reference numeral 10 will be described.

As best illustrated in FIGS. 1 through 5, the bathroom exhaust fan switching device 10 generally comprises a switching module 12, which is configured to be installed in a bathroom 14 so that the switching module 12 is in-line with a bathroom exhaust fan 16, which is positioned in the bathroom 14 and which is operationally engaged to an electrical circuit 18. The switching module 12 comprises a transducer 20, a relay 22, and a microprocessor 24. The transducer 20 is configured to convert sound into an electrical signal. The relay 22 is operationally engaged to the electrical circuit 18. The microprocessor 24, which is operationally engaged to the transducer 20 and the relay 22, is programmed to recognize a sound signature of a shower 26 in the bathroom 14 to the exclusion of sound signatures of other water fixtures in the bathroom 14, such as sinks, toilets, or the like. The microprocessor 24 actuates the relay 22 upon receipt of an electrical signal from the transducer 20 corresponding to the sound signature of the shower 26 so that the bathroom exhaust fan 16 is powered on to remove moist air from the bathroom 14.

The microprocessor 24 may be programmed to maintain the relay 22 in an actuated state for a preset length of time after termination of the electrical signal from the transducer 20. The preset length of time also may be selectively programmable into the microprocessor 24, such as by means of dual in-line package switches (not shown), touch screens, or the like. The preset length of time may be set longer during periods of high ambient humidity or in locations having persistently high humidity.

The switching module 12 may comprise a housing 28, which defines an interior space 30. The transducer 20, the relay 22, and the microprocessor 24 are attached to the housing 28 and are positioned in the interior space 30. The housing 28 is configured for insertion into and attachment to a gang box 32. A plurality of connectors 34 is attached to the housing 28 and is configured to electrically couple the switching module 12 to the electrical circuit 18. Such connectors 34 are well known to those skilled in the art of electrical connections and may include wires, wire connecting elements, or the like. The housing 28 typically would comprise non-conductive plastic and would be fitted with a conductive mounting bracket 36 which would be used to mount the housing 28 within the gang box 32 and which would provide a grounding point. The present invention also anticipates a non-conductive plastic faceplate 38, which would be attached to either the housing 28 or to the gang box 32 to cover the housing 28.

An indicator 40 is attached to the housing 28 and is operationally engaged to the microprocessor 24, positioning the microprocessor 24 to selectively actuate the indicator 40 to display an operational state of the switching module 12. The indicator 40 may comprise a plurality of light emitting diodes 42, each emitting light of a respective color corresponding to an associated operational state of the switching module 12. The plurality of light emitting diodes 42 thus comprises light emitting diodes 42 corresponding to a variety of operational states of the switching module 12. For example, the plurality of light emitting diodes 42 may comprise three light emitting diodes 42, one emitting green light to indicate that the switching module 12 is in an active state, one emitting red light to that indicate the switching module 12 is in an inactive state, and one emitting yellow light to indicate that the switching module 12 is malfunctioning. Each light emitting diode 42 would be aligned with and protrude into or through a respective hole 44 in the faceplate 38.

The switching module 12 may comprise a rectifier 46, thereby allowing it to be powered by the electrical circuit 18. The present invention also anticipates the switching module 12 comprising one or more batteries (not shown), allowing it to operate without drawing power from the electrical circuit 18.

An override switch 48 is attached to the housing 28 and is operationally engaged to the microprocessor 24. Switching of the override switch 48 signals the microprocessor 24 to power on the bathroom exhaust fan 16 without having received the electrical signal from the transducer 20 corresponding to the sound signature of the shower 26, as may be desired to remove foul odors, moisture from a sink, or the like.

The switching module 12 also is anticipated to be integral to a bathroom exhaust fan 16. The indicator 40 in this circumstance would be attached to the bathroom exhaust fan 16 and operationally engaged to the microprocessor 24, positioning the microprocessor 24 to selectively actuate the indicator 40 to display an operational state of the switching module 12. As above, the indicator 40 may comprise a plurality of light emitting diodes 42.

The present invention also anticipates a bathroom exhaust fan switching system 50, which comprises a bathroom exhaust fan 16 that is positioned in a bathroom 14 having a shower 26. The bathroom exhaust fan 16 is in operational engagement with an electrical circuit 18. A switching module 12, according to the specification above, is installed in-line with the bathroom exhaust fan 16. The microprocessor 24 actuates the relay 22 upon receipt of an electrical signal from the transducer 20 that corresponds to the sound signature of the shower 26. Thus, the bathroom exhaust fan 16 is powered on to remove moist air from the bathroom 14.

The bathroom exhaust fan switching system 50 may include a housing 28, which defines an interior space 30. The relay 22 and the microprocessor 24 are attached to the housing 28 and are positioned in the interior space 30. The transducer 20 is attached to the housing 28. The housing 28 is positioned in and is attached to a gang box 32 in the bathroom 14. A plurality of connectors 34 is attached to the housing 28 and electrically couples the switching module 12 to the electrical circuit 18. The present invention also anticipates the switching module 12 of the bathroom exhaust fan switching system 50 being integral to the bathroom exhaust fan 16.

In use and by way of example, the inventors have manufactured a prototype switching module 12 wherein the microprocessor 24 was programmed based on audio recordings in multiple bathrooms 14 with their showers 26 both on and off, with their sinks both on and off, and with their toilets being flushed. The prototype switching module 12 operated with greater than 99% accuracy in automatically powering on the bathroom exhaust fan 16 when the shower 26 was turned on. Thus, the bathroom exhaust fan switching device 10 is anticipated to be supplied with the microprocessor 24 preprogrammed and the switching module 12 ready to function immediately upon installation. The present invention also anticipates the bathroom exhaust fan switching device 10 being configured to allow the microprocessor 24 to be programmable so that the switching module 12 can be tailored to any bathroom 14/shower 26 combination. Programming of the microprocessor 24 may be enabled by dual in-line package switches (not shown), touch screens, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bathroom exhaust fan switching device comprising a switching module configured to be installed in a bathroom, such that the switching module in-line with a bathroom exhaust fan positioned in the bathroom and operationally engaged to an electrical circuit, the switching module comprising:
a transducer configured to convert sound into an electrical signal;
a relay operationally engaged to the electrical circuit; and
a microprocessor operationally engaged to the transducer and the relay and being programmed to recognize a sound signature of a shower in the bathroom to the exclusion of sound signatures of other water fixtures in the bathroom, such that the microprocessor actuates the relay upon receipt of an electrical signal from the transducer corresponding the sound signature of the shower, such that the bathroom exhaust fan is powered on to remove moist air from the bathroom.

2. The bathroom exhaust fan switching device of claim 1, further including the switching module comprising:
a housing defining an interior space, the relay and the microprocessor being attached to the housing and positioned in the interior space, the transducer being attached to the housing, the housing being configured for insertion into and attachment to a gang box; and
a plurality of connectors attached to the housing and being configured to electrically couple the switching module to the electrical circuit.

3. The bathroom exhaust fan switching device of claim 2, further including an indicator attached to the housing and operationally engaged to the microprocessor, positioning the microprocessor to selectively actuate the indicator to display an operational state of the switching module.

4. The bathroom exhaust fan switching device of claim 3, wherein the indicator comprises a plurality of light emitting diodes, each light emitting diode of the plurality of light emitting diodes emitting light of a respective color corresponding to an associated operational state of the switching module, such that the plurality of light emitting diodes comprises light emitting diodes corresponding to a variety of operational states of the switching module.

5. The bathroom exhaust fan switching device of claim 2, further including override switch operationally engaged to the microprocessor, wherein the override switch is configured to be switched to signal to the microprocessor to power on the bathroom exhaust fan without having received the electrical signal from the transducer corresponding the sound signature of the shower.

6. The bathroom exhaust fan switching device of claim 1, wherein the switching module is integral to a bathroom exhaust fan.

7. The bathroom exhaust fan switching device of claim 6, further including an indicator attached to the bathroom exhaust fan and operationally engaged to the microprocessor, positioning the microprocessor to selectively actuate the indicator to display an operational state of the switching module.

8. The bathroom exhaust fan switching device of claim 7, wherein the indicator comprising a plurality of light emitting diodes, each light emitting diode of the plurality of light emitting diodes emitting light of a respective color corresponding to an associated operational state of the switching module, such that the plurality of light emitting diodes comprises light emitting diodes corresponding to a variety of operational states of the switching module.

9. The bathroom exhaust fan switching device of claim 1, wherein the microprocessor is programmed to maintain the relay in an actuated state for a preset length of time after termination of the electrical signal from the transducer.

10. The bathroom exhaust fan switching device of claim 8, wherein the preset length of time is selectively programmable into the microprocessor.

11. A bathroom exhaust fan switching system comprising
a bathroom exhaust fan positioned in a bathroom having a shower, the bathroom exhaust fan being in operational engagement with an electrical circuit; and
a switching module according to claim 1 installed in-line with the bathroom exhaust fan, such that the microprocessor actuates the relay upon receipt of an electrical signal from the transducer corresponding the sound signature of the shower, such that the bathroom exhaust fan is powered on to remove moist air from the bathroom.

12. The bathroom exhaust fan switching system of claim 11, further including the switching module comprising:
a housing defining an interior space, the relay and the microprocessor being attached to the housing and positioned in the interior space, the transducer being attached to the housing, the housing being positioned in and attached to a gang box in the bathroom; and
a plurality of connectors attached to the housing and electrically coupling the switching module to the electrical circuit.

13. The bathroom exhaust fan switching system of claim 11, wherein the switching module is integral to the bathroom exhaust fan.
